(19) United States
(12) Patent Application Publication
(10) Pub. No.: US 2008/0211984 A1
(43) Pub. Date: Sep. 4, 2008

(54) Liquid crystal display device and plasma display device

(76) Inventors: Makiko Sugibayashi, Hitachi (JP); Hiroshi Sasaki, Mito (JP); Katsumi Kondo, Mito (JP); Kiyomi Nakamura, Hitachi (JP); Yasushi Tomioka, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/965,940

(22) Filed: Dec. 28, 2007

(30) Foreign Application Priority Data
Dec. 28, 2006 (JP) 2006-353647

(51) Int. Cl. G02F 1/13357; G02F 1/1335; G02F 1/1333; H01J 17/49

(52) U.S. Cl. 349/58; 349/61; 313/582; 349/137

(57) ABSTRACT

An image display device designed to improve shock resistance and to eliminate external image reflection and blurring. In an liquid crystal display device are disposed a backlight, a polarizing plate on the backlight side and a liquid crystal panel held by two glass substrates and having electrodes, a liquid crystal layer, an alignment layer and a color filter therein. The image display device has a transparent front plate provided on the liquid crystal panel opposite from the backlight, a transparent organic medium layer provided between the front plate and the liquid crystal panel, and an antiglare layer provided on the front plate opposite from the transparent organic medium layer.

### BACKGROUND OF THE INVENTION

The present invention relates to a liquid crystal display device and a plasma display device. More particularly, the present invention relates to a liquid crystal display device or a plasma display device having a transparent front plate on the image display screen.

In an image display device using a liquid crystal, light from a light source is caused to pass through certain members such as a liquid crystal layer interposed between thin glass plates, a color filter and a polarizing plate to be recognized as an image. The outermost surface of such a display device for use as a personal computer monitor or a liquid crystal television display is a polarizing plate. To reduce reflection on the interface between the polarizing plate surface and an air layer, fine irregularities are formed on the polarizing plate surface or an antiglare layer containing particles is formed on the polarizing plate surface.

On the other hand, with the spreading of liquid crystal television sets in ordinary home use, there have been increasing cases of using liquid crystal television displays in homes where pets such as cats and dogs live or in homes where infants live and, hence, increasing cases of the television screen being broken by being struck by an object or by being beaten. Therefore, some liquid crystal television displays are provided with an acrylic front plate to prevent the screen from being broken.

A plasma television display is of a structure using a thick front plate and not easily breakable but has such a large distance from the image formation surface to the outermost surface of the front plate that a displayed image is blurred and obscure if an antiglare layer is used in the outermost surface. Plasma television displays therefore use antireflection film in ordinary cases but are incapable of completely reducing specular reflection and have considerable glare or external image reflection.

JP-A-2003-5662 discloses a structure having antiglare layers on both sides of a front plate.

As described above, in image display devices using a liquid crystal, there is a possibility of a glass plate under a polarizing plate being broken when struck by a piece of tableware, a vase, a toy or the like if the impact of striking is large, because the thickness of the glass plate is about 0.5 to 0.7 mm, varying amount products. There is a trend to develop personal computer monitors and liquid crystal television displays having larger screen sizes. If the screen is larger while the glass thickness is not changed, the impact resistance is reduced and the possibility of breakage by only a small force is increased.

Moreover, in manufacture of a liquid crystal panel, since the two glass plates between which a liquid crystal is sealed in has a small thickness of 0.5 to 0.7 mm, there is a risk of the glass being broken if the liquid crystal panel is held with an unnecessarily large force in each conveyance step in manufacturing or at the time of wiring for example. It is, therefore, necessary to take utmost care on holding the liquid crystal panel or the glass in a manufacturing apparatus in course of manufacture of the liquid crystal panel.

A method of using a transparent front plate on the front side to strengthen the screen is known. However, if an air layer exists between the image display surface and the front plate, the transmittance is reduced or double reflection is caused due to interfacial reflection, resulting in a reduction in visibility.

If no antireflection film or an antiglare layer exists on the light emitting side of the front plate, a surrounding scene is reflected on the screen in a light environment. The antireflection film is incapable of completely reducing specular reflection and there is a limit to the reduction of external image reflection. On the other hand, in the case of antiglare processing, specular reflection is reduced but the displayed image is blurred and the visibility is reduced if the distance from the image display surface to the antiglare distance is increased. In the present circumstances, therefore, no antiglare layer is used in the outermost surface of plasma television displays in which the distance from the image display surface to the front plate is large.

### SUMMARY OF THE INVENTION

The present invention has been made to solve these problems.

The present invention has been achieved by examining various materials and basic constructions and finding, as a result of the examinations, that the problems can be solved chiefly by the following three means.

1): Providing a transparent substrate as a front plate on the outermost surface to improve breakage resistance.

2): Filling the gap between a polarizing plate and the transparent substrate and removing an air layer to reduce interfacial reflection.

3): Reducing external image reflection by providing an antiglare layer in the outermost surface of the front plate.

4): Securing sharpness by specifying the relationship between the distance from an image formation surface to the antiglare surface and a haze with respect to the pixel size.

The following are means for achieving the above-described object.

(1) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a polarizing plate attached to the liquid crystal panel on the light emitting side of the same;

a transparent organic medium layer provided between the front plate and the liquid crystal panel; and

an antiglare layer provided on the front plate on the side of the same not facing the transparent organic medium layer.

(2) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel;

a polarizing plate attached to the front plate on the transparent organic medium layer side of the same; and

an antiglare layer provided on the front plate on the side of the same not facing the transparent organic medium layer.

(3) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a polarizing plate attached to the liquid crystal panel on the light emitting side of the same;

a transparent organic medium layer provided between the front plate and the liquid crystal panel; and

an antiglare layer provided on the front plate on the side of the same not facing the transparent organic medium layer,

wherein the backlight, the liquid crystal panel and the two polarizing plates are housed in a housing, and the front plate is attached to the polarizing plate with the transparent organic medium layer interposed therebetween.

(4) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a polarizing plate attached to the liquid crystal panel on the light emitting side of the same;

a transparent organic medium layer provided between the front plate and the liquid crystal panel; and

an antiglare layer provided on the front plate on the side of the same not facing the transparent organic medium layer,

wherein the backlight, the liquid crystal panel, the two polarizing plates, the transparent organic medium layer and the front plate are housed in a housing.

(5) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a polarizing plate attached to the liquid crystal panel on the light emitting side of the same;

a transparent organic medium layer provided between the front plate and the liquid crystal panel; and

an antiglare layer provided on the front plate on the side of the same not facing the transparent organic medium layer,

wherein the area of the front plate is larger than the liquid crystal panel, and the front plate and a housing are joined to each other.

(6) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel;

a polarizing plate attached to the front plate on the transparent organic medium layer side of the same; and

an antiglare layer provided on the front plate on the side of the same not facing the transparent organic medium layer,

wherein the backlight, the liquid crystal panel and the polarizing plate are housed in a housing, and the front plate is attached to the polarizing plate with the transparent organic medium layer interposed therebetween.

(7) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel;

a polarizing plate attached to the front plate on the transparent organic medium layer side of the same; and

an antiglare layer provided on the front plate on the side of the same not facing the transparent organic medium layer,

wherein the backlight, the liquid crystal panel, the polarizing plate, the transparent organic medium layer and the front plate are housed in a housing.

(8) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel;

a polarizing plate attached to the front plate on the transparent organic medium layer side of the same; and

an antiglare layer provided on the front plate on the side of the same not facing the transparent organic medium layer,

wherein the area of the front plate is larger than the liquid crystal panel, and the front plate and a housing are joined to each other.

(9) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel; and

a polarizing plate attached to the front plate on the light emitting side of the same, with an antiglare layer provided thereon,

wherein the backlight, the liquid crystal panel and the polarizing plate are housed in a housing, and the front plate is attached to the polarizing plate with the transparent organic medium layer interposed therebetween.

(10) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel; and

a polarizing plate attached to the front plate on the light emitting side of the same, with an antiglare layer provided thereon,

wherein the backlight, the liquid crystal panel, the polarizing plate, the transparent organic medium layer and the front plate are housed in a housing.

(11) A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device including:

a transparent front plate provided on the liquid crystal panel on the side of the same not facing the backlight;

a transparent organic medium layer provided between the front plate and the liquid crystal panel; and

a polarizing plate attached to the front plate on the light emitting side of the same, with an antiglare layer provided thereon,

wherein the area of the front plate is larger than the liquid crystal panel, and the front plate and a housing are joined to each other.

(12) The liquid crystal display device according to (1) to (11), wherein a driver IC for controlling LCD is disposed in a lower portion of the liquid crystal display device.

(13) The liquid crystal display device according to (1) to (12), wherein the thickness of the transparent organic medium layer is 0.1 to 10 mm.

(14) The liquid crystal display device according to (1) to (13), wherein if the refractive index of a constituent member of the transparent organic medium layer is n and the refractive index of the front plate is n₀, these refractive indices satisfy the following expression:

n₀−0.2<n<n₀+0.2.

(15) The liquid crystal display device according to (1) to (14), wherein the transparent organic medium layer contains a compound capable of absorbing light in a visible range.

(16) The liquid crystal display device according to (1) to (15), wherein the compound capable of absorbing light in a visible range is a compound having a uniaxial anisotropy.

(17) The liquid crystal display device according to (1) to (16), wherein if the distance from an image formation surface to an antiglare layer surface is L (mm), the distance L satisfies the following expression:

2.1≦L.

(18) A plasma display device having a plasma display panel in which a plurality of discharge cells of one or a plurality of colors are arrayed between a pair of glass substrates, and fluorescent luminous layers of colors corresponding to the discharge cells are disposed between the glass substrates and are excited with ultraviolet rays to emit light, the plasma display device including:

a transparent front plate provided on the plasma display panel on the light emitting side of the same;

a transparent organic medium layer provided between the front plate and the plasma display panel; and

an antiglare layer provided on the front plate on the side of the same not facing the transparent organic medium layer.

(19) The plasma display device according to (18), wherein the thickness of the transparent organic medium layer is 0.1 to 10 mm.

(20) The plasma display device according to (18) or (19), wherein if the refractive index of a constituent member of the transparent organic medium layer is n and the refractive index of the front plate is no, these refractive indices satisfy the following expression:

n₀−0.2<n<n₀+0.2.

(21) The liquid crystal display device or the plasma display device according to claim (1) to (20), wherein if the blur width of the liquid crystal display device or the plasma display device is d (mm) and the pixel size of the liquid crystal display device or the plasma display device is D (mm), the blur width satisfies the following expression:

d<2·D.

(22) The liquid crystal display device or the plasma display device according to claim (1) to (21), wherein if the blur width of the liquid crystal display device or the plasma display device is d (mm) and the pixel size of the liquid crystal display device or the plasma display device is D (mm), the blur width satisfies the following expression:

d<(⅔)·D.

(23) The liquid crystal display device or the plasma display device according to (1) to (22), wherein if the distance from an image formation surface to an antiglare surface in the liquid crystal display device or the plasma display device is L (mm); a haze of the antiglare is H; and the pixel size of the liquid crystal display device or the plasma display device is D (mm), the distance, the haze and the pixel size satisfy the following expression:

L·H/D<200.

(24) The liquid crystal display device or the plasma display device according to claim (1) to (22), wherein if the distance from an image formation surface to an antiglare surface in the liquid crystal display device or the plasma display device is L (mm); a haze of the antiglare is H; and the pixel size of the liquid crystal display device or the plasma display device is D (mm), the distance, the haze and the pixel size satisfy the following expression:

L·H/D<150.

The breakage resistance is improved by providing the front plate on the image display panel. Also, it has been shown that the reflectance on the air interface is reduced in comparison with a case where no organic medium is provided.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIGS. 1(A) to 1(C) are diagrams for explaining a blur width;

FIG. 2 is a diagram schematically showing a process of filling with a transparent organic medium when a liquid crystal display device of the present invention is manufactured;

FIG. 3 is a diagram schematically showing a transparent organic medium layer containing layer thickness control particles used in the present invention;

FIGS. 4(A) to 4(C) are schematic sectional views (1) of liquid crystal modules for the liquid crystal display device of the present invention;

FIGS. 5(A) and 5(B) are schematic sectional views of the liquid crystal display device of the present invention;

FIGS. 6(A) to 6(C) are schematic sectional views (2) of liquid crystal modules for the liquid crystal display device of the present invention;

FIGS. 7(A) and 7(B) are diagrams showing polarizing plate/liquid crystal cell/polarizing plate/backlight portions of the liquid crystal display device of the present invention;

FIGS. 8(A) and 8(B) are diagrams showing polarizing plate/liquid crystal cell/polarizing plate/backlight/housing portions of the liquid crystal display device of the present invention;

FIGS. 9(A) and 9(B) are diagrams showing polarizing plate/liquid crystal cell/polarizing plate/backlight portions of the liquid crystal display device of the present invention;

FIG. 10 is a diagram showing a backlight portion of the liquid crystal display device of the present invention constituted by a polarizing plate/liquid crystal cell/polarizing plate/light emitting diode;

FIG. 11 is a diagram showing the structure of a light emitting diode constituting a backlight for the liquid crystal display device of the present invention;

FIGS. 12(A) to 12(C) are schematic sectional views (3) of liquid crystal modules for the liquid crystal display device of the present invention;

FIGS. 13(A) to 13(C) are schematic sectional views (4) of liquid crystal modules for the liquid crystal display device of the present invention;

FIGS. 14(A) to 14(C) are schematic sectional views (5) of liquid crystal modules for the liquid crystal display device of the present invention; and

FIGS. 15(A) to 15(C) are schematic sectional views (6) of liquid crystal modules for the liquid crystal display device of the present invention.

### DESCRIPTION OF SYMBOLS

1 Liquid crystal panel
2 Polarizing plate
3 Bank
4 Transparent organic medium
5 Front plate
6 Layer thickness control particle
7 Antiglare layer
8 Backlight
9 Liquid crystal module
10 Power supply unit
11 Control system
12 Front outer frame
13 Rear outer frame
14 Housing
15 LCD control driver IC
16 FPC substrate
17 Casing
18 Reflective sheet
19 Cold cathode fluorescent lamp
20 Diffusion plate
21 Diffusion sheet
22 Prism sheet
23 Top lid of casing
24 Light emitting diode
25 Light emitting portion
26 Reflective surface

### DETAILED DESCRIPTION OF THE INVENTION

The outline of the present invention will first be described. The present invention is not limited to concrete examples of the invention described below as long as the scope of the present invention is not surpassed.

For outlining of the present invention, description will first be made of “blur width” and “distance from image formation surface to antiglare layer”.

### [1] About Blur Width

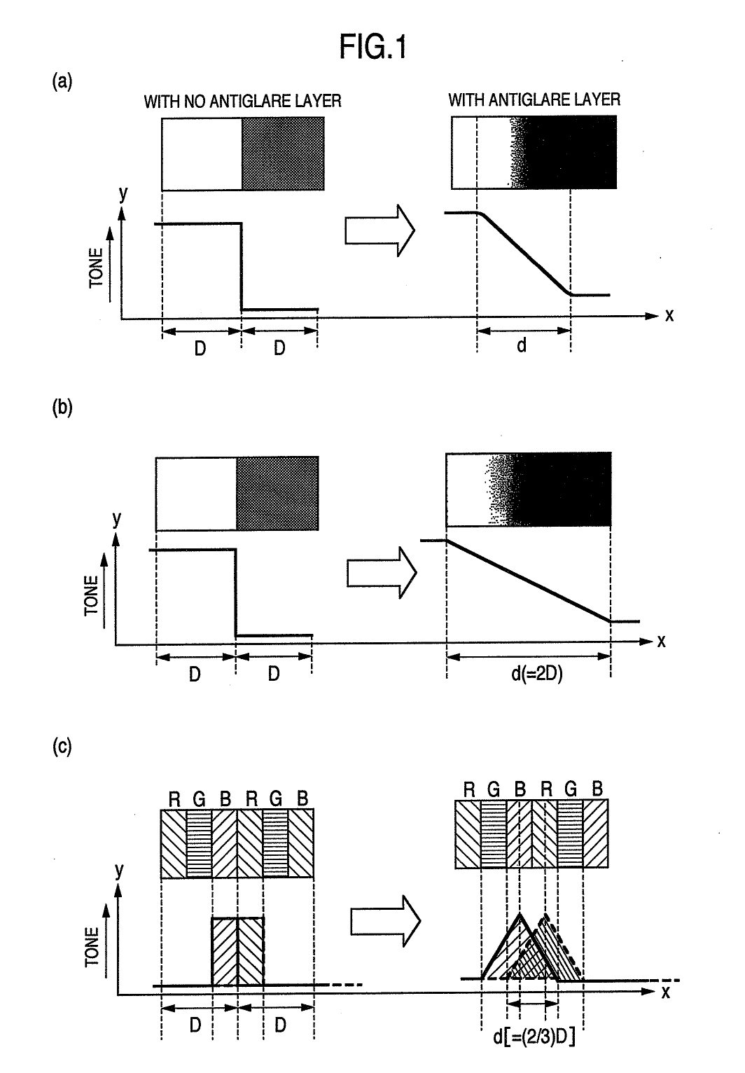

FIG. 1(A) shows a diagram for explaining a blur width. The size of one pixel is assumed to be D. When two pixels adjacent to each other are displayed in white and black, portions of the pixels adjacent to each other appears as a portion of a luminance between white and black (gray). The width of this region is defined as a blur width (d).

More specifically, the blur width is obtained by a procedure shown in 1) to 4) below.

1) A logarithm of the luminance of white and black images is assumed to be a tone; the maximum of tone in the y-axis direction is assumed to be 100; the minimum of tone is assumed to be 0; and the range of tone is divided into 100.

2) To reduce variation in tone with respect to each image, ten lines are drawn parallel to each other in the x-axis direction and the average of tone is obtained.

3) The tone average value is obtained by a moving average method. The number of pixels from which the average value is obtained is 11. The pixel average value is then plotted in a graph.

4) The human visual sensitivity is higher at about 550 nm. In the graph of the green pixel average value closer to this value, the distance between a position of −5% from the maximum and a position of +5% from the minimum is measured. This is the blur width.

An allowable blur width in a black and white image will be described with reference to FIG. 1(B). For example, in a case where one of two pixels adjacent to each other is displayed in white and the other is displayed in black, each pixel becomes gray if the blur width is equal to or larger than the total width of the two pixels. For the existence of certain non-gray portions, i.e., white and black portions, therefore, it is necessary that the blur width be smaller than the total width of the two pixels.

An allowable blur width in a color image will be described with reference to FIG. 1(C). One pixel is divided into three and constituted by R (red), G (green) and B (blue). For example, in a case where blue is displayed by one pixel, light passes through the blue portion but no light passes through each of the red and green portions. In a case where different colors are displayed in two pixels adjacent to each other, and where the two color portions are adjacent to each other, the adjacent colors are completely mixed if the blur width is equal to or larger than the width of one pixel. The purities of colors are thereby reduced. In designing a panel of a finer resolution, therefore, setting the blur width to a value smaller than ⅔ of the width of one pixel is required for the existence of a region where there is no influence of an adjacent color.

[2] About the Distance from Image Formation Surface to Antiglare Layer

In a liquid crystal display device, the quantity of light emitted from a backlight controlled by the liquid crystal layer with respect to each pixel and the tone is adjusted when the light is passed through a color filter, thus forming an image. “Image formation surface” refers to the surface on which the color filter is formed in the liquid crystal display device. In a plasma display panel, fluorescent luminous layers placed in correspondence with discharge cells are excited by ultraviolet rays to emit light, thereby forming an image. Accordingly, “image formation surface” refers to the surface of the front substrate on the fluorescent luminous layer side. Let the distance from the image formation surface to an antiglare layer provided in the outermost surface of a front plate on the light emission side be L (mm). If the distance is small, a mark made by wiping the screen with a cloth or the like or by rubbing the screen remains for a while.

In a structure having on a liquid crystal panel a front plate to which an antiglare film is attached and having a gap filled with a transparent organic medium between the front plate and the liquid crystal panel, pressing by applying a load of about 2 kg/cm² on the front plate surface and moving the application point from left to light through a distance of 100 mm at a speed of about 100 mm/sec were performed for an action assumed to be performed by a person to wipe off dirt. When the distance L from the image formation surface to the antiglare layer is 2.0 mm or less, a mark made by pressing remained for several seconds. When the distance was 2.1 mm or more, no mark made by pressing remained. Accordingly, it is necessary that the distance from the image formation surface to the antiglare layer be 2.1 mm or more. The results of a corresponding test on examples of the present invention will be described later in detail.

### [A] Constituent Units, Members, etc., of the Present Invention

### A-1. Image Display Unit

“Image display unit” in the present invention refers to a unit such as liquid crystal module or a plasma display panel for displaying an image. The method of displaying an image is not limited to the liquid crystal display method and the plasma display method. Any other image display method may be used.

◯ Liquid Crystal Module

“Liquid crystal module” refers to a constituent unit formed of a backlight which is a light source, a polarizing plate, a liquid crystal panel and a casing in which these components are housed.

Backlight

“Backlight” refers to a unit constituted by a light source members consisting of cold cathode fluorescent lamps or light emitting diodes (LEDs), optical members, such as a reflective sheet, a diffusion plate, a prism sheet, a reflective polarizing sheet and a light guide plate, and a backlight holding housing for holding the light source members and optical members.

Polarizing Plate

A polarizing plate is a plate having a function to transmit only light in a particular vibration direction. In the present invention, any particular polarizing plate is not specified, and one used in ordinary liquid crystal display devices is employed.

Two polarizing plates are used in one display device. One polarizing plate is provided between the backlight and the liquid crystal layer.

This polarizing plate is positioned on the back surface side relative to the image formation surface and, therefore, use/nonuse of surface treatments such as antifouling treatment, antiglare treatment and antireflection treatment does not influence image sharpness.

Accordingly, no specification is made as to whether or not each surface treatment is to be performed.

Another polarizing plate is provided between the liquid crystal layer and a front plate or on the light-emission-side surface of the front plate.

The above-described surface treatments may also be omitted with respect to the polarizing plate used between the liquid crystal layer and the front plate.

However, in a case where a polarizing plate is provided on the light-emission-side outermost surface of a front plate, there is a need to use a polarizing plate having an antiglare layer as a surface treated layer for preventing external image reflection, or to attach an antiglare film on the surface of the polarizing plate if the polarizing plate has no antiglare layer.

Liquid Crystal Panel

A liquid crystal panel having transparent electrodes, an alignment layer, a liquid crystal layer, alignment layer and a color filter held in this order from the side facing the backlight between two glass substrates is ordinarily provided. The liquid crystal panel in the present invention is also based on this construction.

Even a liquid crystal display device of a construction partially different from the above-described construction falls within the category of the liquid crystal display device according to the present invention if it performs the same function.

◯ Plasma Display Panel

“Plasma display panel” in this specification refers to a device constituted by two glass substrates, an array of a plurality of discharge cells for one color or a plurality of colors between the glass substrates, and fluorescent luminous layers of the corresponding colors provided in correspondence with the discharge cells. The fluorescent luminous layers are excited with ultraviolet rays to emit light.

### A-2. Front Plate

A front plate in the form of a transparent plate which absorbs substantially no light in the visible range and which has high resistance to rubbing is preferred.

It is desirable that the thickness of the front plate, depending on the size of the image display area, be 0.7 mm or more if the front plate is made of glass, and 1 mm or more if the front plate is made of an acrylic resin or the like. If the thickness is smaller than this value, the front plate is deformed at the time of manufacture and the deformation affects the flatness of the display surface of the product.

The larger the thickness the front plate, the larger the weight of the front plate becomes. The increase in weight becomes considerably large with increase in screen size. With increase in weight of the front plate, a need arises to reinforce the body of a television set and a stand for the television set and to increase the rigidity thereof. This leads to an increase in overall weight. Then it is desirable that the thickness of the front plate made of glass be 4 mm or less, and the thickness of the front plate made of a resin be 5 mm or less.

The front plate may be larger in size than a transparent organic medium layer described below, the polarizing plate, the liquid crystal panel and the backlight.

The light-emission-side surface of the front plate may be roughened to reduce external image reflection.

### A-3. Transparent Organic Medium

A transparent organic medium in the present invention is in a solid or liquid state at ordinary temperature. If the refractive index of the transparent organic medium is closer to the refractive index of the substrate in contact with the transparent organic medium, e.g., the front plate, the liquid crystal panel or the plasma display panel, or the polarizing plate, the effect of reducing the reflectance on the interface between the transparent organic medium and the substrate is improved.

The composition of the front plate is, for example, glass (refractive index: about 1.50 to 1.54), an acrylic resin (refractive index: about 1.49), polyethylene terephthalate (PET) (refractive index: about 1.56), polycarbonate (refractive index: about 1.59), triacetylcellulose (refractive index: about 1.5).

If the refractive index of the front plate is no and the refractive index of the transparent organic medium is n, the reflectance R on the interface between the front plate and the transparent organic medium is obtained by the following equation:

R={(n₀−n)/(n₀+n)}²

In a state where no transparent organic medium exists inside the front plate, that is, there is an air layer (refractive index: 1.0), reflection at about 4 to 5% occurs on the interface between the front plate and the air layer.

As the substrate of the image display panel, e.g., the liquid crystal panel or the plasma display panel, a glass substrate, triacetylcellulose or the like is used, as in the case of the front plate. Accordingly, reflection at about 4 to 5% also occurs on the interface between the substrate and the air layer.

The polarizing plate has on its one surface an adhesive layer and on the other surface no surface treated layer or a certain surface treated layer such as a hard coat layer, an antiglare layer, an antireflective layer. The refractive index of the surface treated layer is generally 1.3 to 1.6, depending on the surface treatment by which the surface treated layer is formed. Accordingly, reflection at about several percents also occurs on the interface between the polarizing plate and the air layer, as does that on the interface between the front plate and the air layer.

Reflection is caused by the difference between the refractive indices of the substrate, e.g., the front plate, and the air layer. Therefore, reflection can be reduced if a transparent medium having a refractive index closer to that of the substrate is substituted for air in the air layer.

Under direct rays of the sun, the visibility is improved substantially largely if the reflectance on the interface between the front plate and the transparent organic medium, about 4 to 5%, is reduced to about 0.5%. The refractive index at which the reflectance of one side was reduced to about 0.5% as a result of filling with each of different transparent organic mediums was examined from the above equation. Table 1 below shows the results of this examination.

TABLE 1
Differences between the refractive indices of substrates and transparent
organic mediums and the reflectance

| Refractive | Refractive index | | |
|---|---|---|---|
| index of | of transparent | \|n₀ − n\| | |
| substrates | organic mediums | (difference | Reflectance |
| (n₀) | (n) | from n₀) | (%) |
| 1.48 | 1.28 | 0.20 | 0.53 |
| ↑ | 1.38 | 0.10 | 0.12 |
| ↑ | 1.18 | 0.25 | 0.85 |
| 1.54 | 1.34 | 0.20 | 0.48 |
| 1.59 | 1.39 | 0.21 | 0.50 |
| 1.48 | 1.70 | 0.22 | 0.48 |
| 1.54 | 1.77 | 0.23 | 0.48 |
| 1.59 | 1.83 | 0.24 | 0.49 |

This table shows that with respect to each substrate it is desirable to set the difference between the refractive indices of the substrate and the transparent organic medium to 0.2 or less in reducing the reflectance to about 0.5%.

Therefore, if the refractive index of each substrate is n₀ and the refractive index of each transparent organic medium is n, it is desirable to make selections from the substrate and the transparent organic mediums such that an inequality shown below is satisfied.

n₀−0.2<n<n₀+0.2

Materials shown below are named as examples of transparent organic mediums.

As examples of transparent organic mediums in a solid state, thermosetting resins, photocurable resins and the like obtained by polymerizing monomers by thermosetting or photocuring are named. Thermoplastic resins already polymerized are also named.

The gap between the image display panel and the front plate is filled with the monomer of such a thermosetting resin or a photocurable resin, and heat or light is thereafter applied suitably to the monomer to set the monomer, thus enabling closing the gap. As the monomers of such resins, a monomer to be polymerized by using double bond therein, different monomers or polymers to be polymerized, a monomer to be polymerized by dehydration reaction, a monomer to be polymerized by alcohol elimination reaction, and other monomers are named.

As monomers to be polymerized by using double bond therein, styrene, methyl methacrylate, ethyl methacrylate, propyl methacrylate, iso-propyl methacrylate, butyl methacrylate, iso-butyl methacrylate, hexyl methacrylate, octyl methacrylate, 2-ethylhexyl methacrylate, decyl methacrylate, dodecyl methacrylate, methyl acrylate, ethyl acrylate, propyl acrylate, iso-propyl acrylate, butyl acrylate, iso-butyl acrylate, hexyl acrylate, octyl acrylate, 2-ethylhexyl acrylate, decyl acrylate, and dodecyl acrylate are named. One or more of these monomers are used to form the transparent organic medium layer. Also, copolymerization between these monomers and other polymers or monomers may be performed to form the transparent organic medium layer. As polymers used in such a case, polyacrylic acid, polyvinyl alcohol and other polymers are named. Also, as monomers in such a case, those having hydroxyl groups in molecules, e.g., ethylene glycol, propylene glycol, diethylene glycol, 1,3-dihydroxycyclobutane, 1,4-dihydroxycyclohexane, and 1,5-dihydroxycyclooctane and those having glycidyl groups at their ends, e.g., ethylene glycol monoglycidyl ether and ethylene glycol diglycidylether are named.

As monomers and polymers polymerized by dehydration reaction, those having two or more hydroxyl groups or glycidyl groups at one end, those having two or more amino groups at one end and those having two or more carboxyl groups or a carboxyl acid anhydride structure at one end and condensation-polymerized are named. As those having hydroxyl groups at their ends, ethylene glycol, propylene glycol, diethylene glycol, 1,3-dihydroxycyclobutane, 1,4-dihydroxycyclohexane, 1,5-dihydroxycyclooctane, and polyethylene glycol are named. As those having glycidyl groups at their ends, ethylene glycol monoglycidyl ether and ethylene glycol diglycidyl ether are named. As those having amino groups at their ends, ethylenediamine, 1,4-diaminobutane, 1,6-diaminohexane, 1,4-diaminobenzene, 2,6-diaminonaphthalene, and melamine are named. As those having carboxyl groups at their ends, adipic acid, 1,3-phthalic acid, 1,4-phthalic acid, fumaric acid, maleic acid, trimesic acid, and pyromellitic acid are named. As those having a carboxyl acid anhydride structure at their ends, malefic anhydride, phthalic anhydride, trimellitic anhydride, and pyromellitic anhydride are named. As monomers to be polymerized by alcohol elimination reaction, compounds having alkoxy silane groups and compounds having alkoxy titan groups are named. More specifically, tetramethoxy silane, tetraethoxy silane, tetrapropoxy silane, tetrabutoxy silane, methyl trimethoxy silane, ethyl trimethoxy silane, butyl trimethoxy silane, methyl triethoxy silane, ethyl triethoxy silane, butyl triethoxy silane, 1-aminopropyl triethoxy silane, 1-chloropropyl triethoxy silane, and 1-glycidyipropyl triethoxy silane are named.

Also, a material having high elasticity, e.g., polyisobutylene or polyvinyl butyral may be used to improve the shock-absorbing function of the transparent organic medium layer. The range of elasticity of the transparent organic medium layer is preferably from hardness 5 to hardness 40 as measured in accordance with the rubber hardness measurement standard JIS K 6253, and more preferably from hardness 10 to hardness 30. If the hardness is lower than 5, there is a risk of reducing the reliability with which the front plate is held in the liquid crystal display device for a long time period. If the hardness exceeds 40, the shock-absorbing effect tends to become lower.

As thermoplastic resins, polystyrene, styrene/acrylic resin, acrylic resin, polyester resin, polypropylene, and polyisobutylene are named. The facility with which filling with one of these resins is performed can be improved by liquefying the resin by heating at Tg or higher.

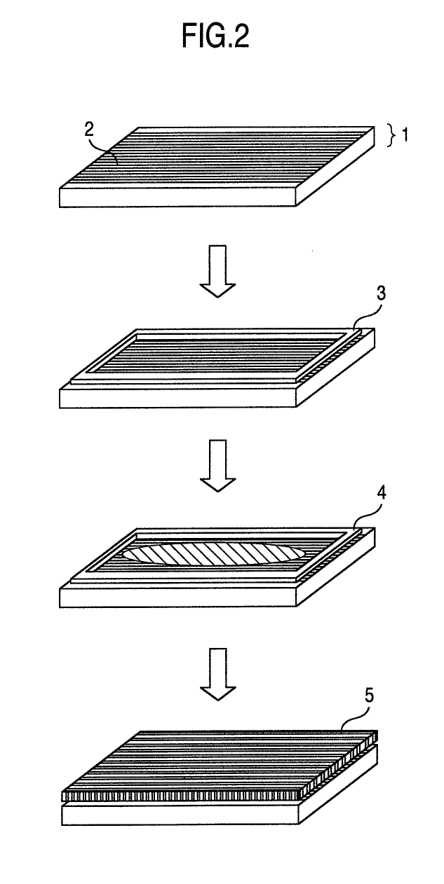

FIG. 2 schematically shows a process. If the transparent organic medium is a liquid, or if the monomer is a liquid, filling with the transparent organic medium is performed by a method described below. A bank is provided on a peripheral portion of the member (a front plate, a polarizing plate or an image display panel, e.g., a liquid crystal panel) that the transparent organic medium contacts. For example, the polarizing plate 2 is attached to the liquid crystal panel 1 and a bank 3 is provided on the polarizing plate 2. Also in the case of the transparent organic medium layer in the figure showing the construction of the liquid crystal module described later, a bank, not shown in the figure, is provided if a transparent organic medium 4 is a liquid or the monomer is a liquid. Subsequently, the transparent organic medium 4 is poured in and a front plate 5 is placed on the medium. If air bubbles are contained, they are removed, for example, by pressing or pressing and heating with a suitable device such as an autoclave, by applying vibration with a vibrator or the like or by suction.

It is preferable to improve the wettability of the portion that the transparent organic material contacts for the purpose of facilitating expelling of air bubbles. More specifically, it is preferable to improve the wettability of the surface of contact between the transparent organic medium and the front plate, the polarizing plate or the image display panel, e.g., the liquid crystal panel. If the wettability is improved, the transparent organic medium can easily attach to the surface relative to air. As a result, expelling of air bubbles is facilitated. A preferable concrete condition for the wettability in terms of condition with respect to water is an angle of contact of 20° or less with water. If this condition is satisfied, filling with almost every organic material can be achieved while avoiding inclusion of air bubbles. Preferably, to reduce air bubbles more effectively, the angle of contact with water is set to 10° or less.

A transparent member is used as the bank to enable recognition of an image through any portion of the image display surface even if a portion of the image display surface is covered with the bank. If any portion of the image display surface is not covered with the bank, it is not necessary to use a transparent bank. In such a case, a black bank is preferred in terms of improvement in image highlighting.

The transparent organic medium layer may be larger in size than the polarizing plate and the liquid crystal panel as seen in an illustration of the construction of the liquid crystal module described below.

If the transparent organic medium is a liquid, a solvent having such a comparatively high boiling point as not to be easily vaporizable by heat generated by the liquid crystal display device is preferred as the liquid. As examples of such a solvent, alcohols (in which the number of carbon atoms is 6 or more), diols (such as ethylene glycol and propylene glycol), hydrocarbon (10 carbons or more), ethylene glycol monoalkylether, ethylene glycol monoalkylester, diethylene glycol monoalkylether, diethylene glycol monoalkylester, triethylene glycol monoalkylether, and triethylene glycol monoalkylester are named.

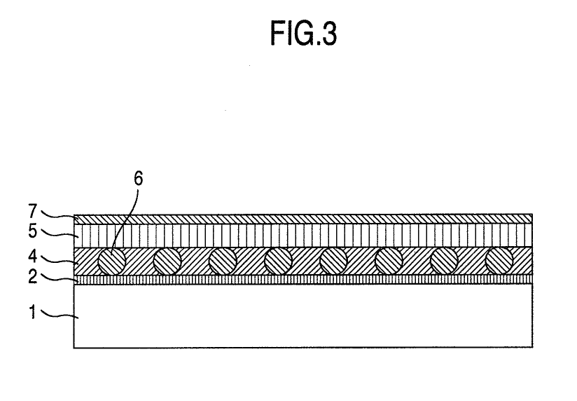

In a case where the transparent organic medium is a liquid, it is desirable to set the thickness of the transparent organic medium layer to 0.1 mm or more in for the purpose of ensuring the desired accuracy at the time of formation of the bank or facilitating expelling of air bubbles. If the thickness is excessively large, the weight of the transparent organic medium in liquid form in particular is considerably increased and it is difficult to retain the liquid with the bank. For this reason, it is desirable that the maximum of the thickness be 10 mm or less. A method of using transparent particles (layer thickness control particles) 6 having a diameter substantially equal to the target thickness may be used for the purpose of uniformly setting the thickness. FIG. 3 schematically shows this method. In the gap to be filled with the transparent organic medium 4, the above-described particles are put in advance so as not overlap each other. The gap is thereafter filled with the transparent organic medium.

This method enables control of the thickness of the transparent organic medium layer through setting of the diameter of the particles. Particles for this purpose will be referred to as layer thickness control particles.

Layer thickness control by packing layer thickness control particles in a state of being mixed in the transparent organic medium may alternatively be performed.

A process described below may also be performed. The gap for the transparent organic medium layer is filled with a photocurable resin monomer in which a pigment having absorption anisotropy is dissolved, and the monomer is irradiated with light polarized by using a polarizer. When the monomer is set, the pigment also has an absorption axis, thereby enabling the transparent organic medium layer to function as an auxiliary polarizing plate. It is also possible to reduce leakage of light in black display on a liquid crystal in this way.

There is a problem that a pigment used in the color filter scatters light from the light source and the scattered light leaks at the time of black display to reduce the degree of contrast. However, a pigment capable of absorbing the scattered light may be contained in the transparent organic medium to limit the reduction in the degree of contrast. Also, the liquid crystal display device has a bluish tone at the time of black display, because leakage of light in the wavelength region from 400 to 450 nm is stronger than those in other wavelength regions. Then a pigment which absorbs light of 400 to 450 nm is contained in the transparent organic medium to limit reduce bluishness at the time of black display, thus enabling clear black display. Inorganic or metallic nanoparticles other than pigments also have a light absorption effect based on a quantum size effect.

### A-4. Antiglare Layer

An antiglare layer is used to avoid reflection of a surrounding scene when the screen is viewed in a light environment. Reflection on the antiglare layer is prevented by forming irregularities in the surface or dispersing contained particles in the layer. If the particle size of the contained particles is several ten μm or greater, in-surface variations occur in the haze value of the antiglare layer. Therefore it is preferred that the particle size of the contained particles be several ten μm or smaller.

The antiglare layer may be a layer on an antiglare film having a transparent resin such as triacetylcellulose or PET or the polarizing plate as a base member, an adhesive on one side and the antiglare layer on the other side. The antiglare layer may alternatively be formed as a coating directly on the front plate or may be formed by roughing the surface of the front plate. In any of such cases, it is necessary that the antiglare layer be provided at least on the light emitting side surface of the front plate. For example, the antiglare layer may be formed on the both sides of the front plate. As a method for roughing to form the antiglare layer, a physical process using sandblast or a chemical process in which the front plate is immersed in a solution capable of dissolving the material of the front plate (a solution of a strong base if the front plate is formed of glass).

### A-5. Housing

“Housing” refers to a casing in which are provided the image display unit, the front plate, the organic transparent resin, the antiglare layer, and devices necessary for displaying images, including a power supply, and which covers these components from the back. The material, shape, color, etc., or the housing are not particularly specified as long as the housing has the functions to protect and hold the internal members.

### A-6. LCD Control Driver IC

An active-matrix-type liquid crystal display device has a signal line drive circuit and a scanning line drive circuit for driving the liquid crystal panel, and a timing controller for controlling the signal line drive circuit and the scanning line drive circuit. This controller is called a LCD control driver IC.

The LCD control driver IC is mounted in an upper portion of the liquid crystal module in some products or a lower portion of the liquid crystal module in other products.

### [B] Construction of Image Display Device

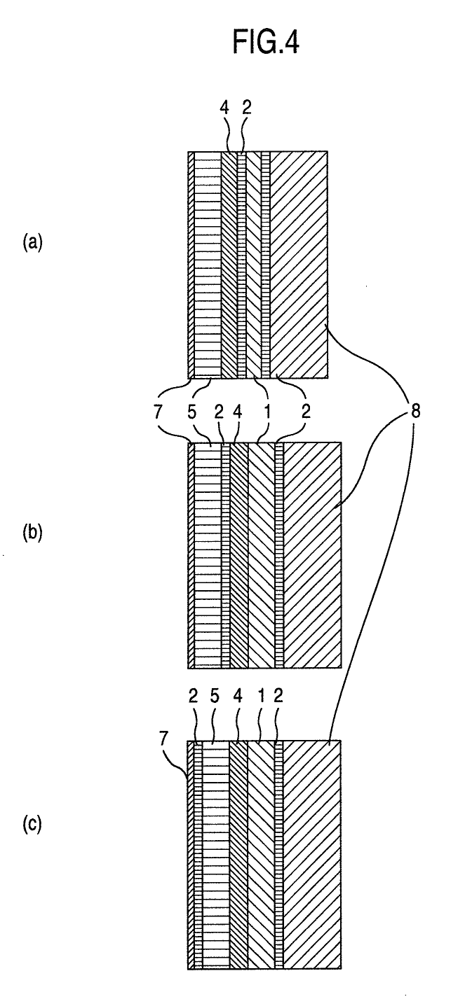

The construction of the image display device of the present invention will be described with reference to FIGS. 4 to 15. Description will be made of a liquid crystal display device by way of example. However, a display device formed by substituting a plasma display panel for the liquid crystal module also has the same antiglare layer, front plate, transparent organic medium and housing as those of the liquid crystal display device. However, the polarizing plate is provided only in the liquid crystal module.

### (1) With Front Plate Forming the Outermost Surface

Personal computer monitors and liquid crystal television sets currently on the market have a structure having an antiglare film 7 on the surface of a polarizing plate without having a transparent organic medium 4 and a front plate 5 shown in FIG. 4(A). Referring to FIG. 4(A), in this structure, a polarizing plate 2, a liquid crystal panel 1 and a polarizing plate are superposed on a backlight 8. A combination of these members is referred to as “liquid crystal module. The liquid crystal panel is formed of a liquid crystal layer placed between a pair of transparent glass plates, a color filter layer, an electrode structure for applying electric fields to the liquid crystal layer and various insulating films. A module constituted by a combination of a liquid crystal panel thus constructed, a polarizing plate for changing an optical characteristic and a backlight provided as a light source and a driver IC for driving the LCD is referred to as “liquid crystal module”. In such a module, the glass plates of the liquid crystal panel have a small thickness of 0.7 mm and are, therefore, easily breakable when struck by an object.

In the present invention, the front plate is provided as shown in FIG. 4(A) to improve breakage resistance. Also, the gap between the front plate and the polarizing plate is filled with the transparent organic medium to reduce reflection on the back surface of the front plate and reflection on the polarizing plate. Further, an antiglare film is attached on the outermost surface to reduce reflection of external light. If the surface of the antiglare film is scratched or dust is attached to the surface in the manufacturing process, reattachment of a new antiglare film can be performed. In a case where the antiglare film is formed by direct application on the front plate, the need for an adhesive layer and a separator film required for the antiglare film is eliminated to achieve an environmental load reduction effect. The method of forming an antiglare layer by directly roughening the front plate has the advantage of preventing separation of the antiglare layer even when the surface is strongly rubbed with a cloth or the like at the time of cleaning.

The polarizing plate to be interposed between the liquid crystal panel and the transparent organic medium layer is attached to the liquid crystal panel in a manufacturing step. In this step, there is a need to accurately align the polarization axis. Once the polarizing plate is attached, reattachment cannot be performed. However, if the polarizing plate is attached as shown in FIG. 4(B), the polarization axis can be aligned when the polarizing plate is fixed, thus obtaining the advantage of improving the accuracy.

This is possible because there is no problem in image display even with a situation where the attached position of the front plate itself is slightly shifted.

Referring to FIG. 4(C), the polarizing plate is provided on the front plate and an antiglare layer 7 is formed on the polarizing plate. This structure comprises one layer (a polarizing plate with an antiglare layer) functioning as the above two layers and has the advantage of eliminating the need for newly attaching an antiglare film.

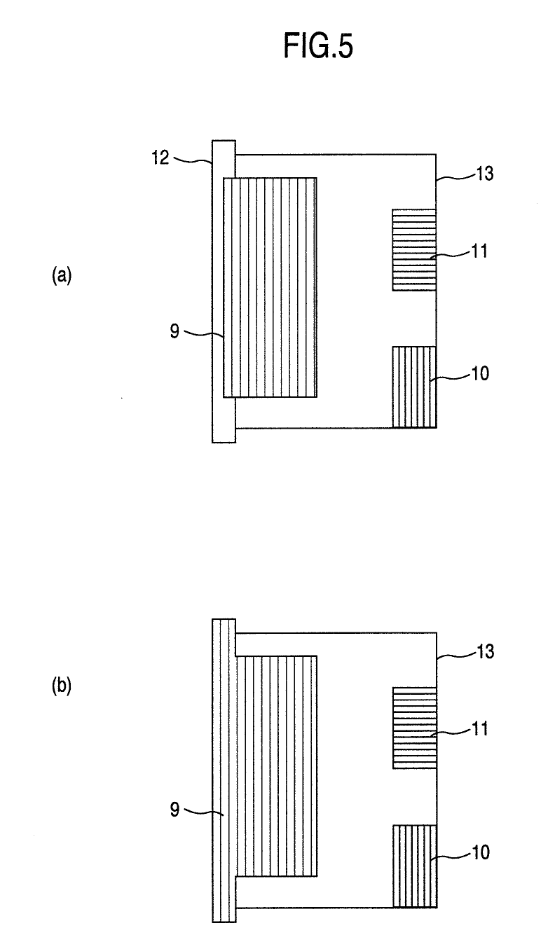

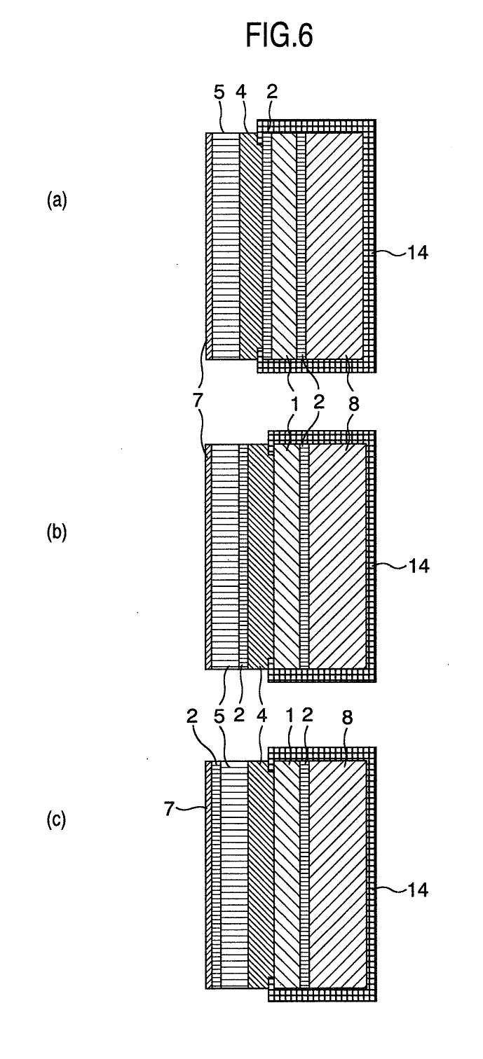

As shown in FIG. 5(A), a liquid crystal display device is made by attaching a liquid crystal module 9 constructed as described above, a power supply unit 10, a control system 11, a front outer frame 12 and a rear outer frame 13. FIG. 5(A) shows an example of a case where the size of the front plate is substantially equal to that of the liquid crystal panel, and FIG. 5(B) shows an example of a case where the size of the front plate described below is smaller than that of the liquid crystal panel as described below. FIG. 5(B) shows a case where no front outer frame exists. There is no particular functional problem with such a case. Each of liquid crystal modules described below with reference to FIGS. 6 and 12 to 15 has the same construction as that in the liquid crystal display device shown in FIG. 5.

### (2) Holding Liquid Crystal Module in Housing

In personal computer monitors and liquid crystal television sets currently on the market, the backlight, polarizing plate, liquid crystal panel and polarizing plate shown in FIG. 6(A) are held together in a housing 14 to form a liquid crystal module. A control system, a power supply, outer frames, etc., are attached to this module to enable functioning as an image display device. The transparent organic medium layer and the front plate can be attached after making the liquid crystal module. This construction has the advantage of enabling making without changing the conventional liquid crystal module manufacturing process.

FIGS. 6(B) and 6(C) show cases where the polarizing plate is attached on the light incidence side or the light emitting side of the front plate. The effects of these constructions are the same as those of the constructions shown in FIGS. 4(B) and 4(C) with respect to the above-described case (1).

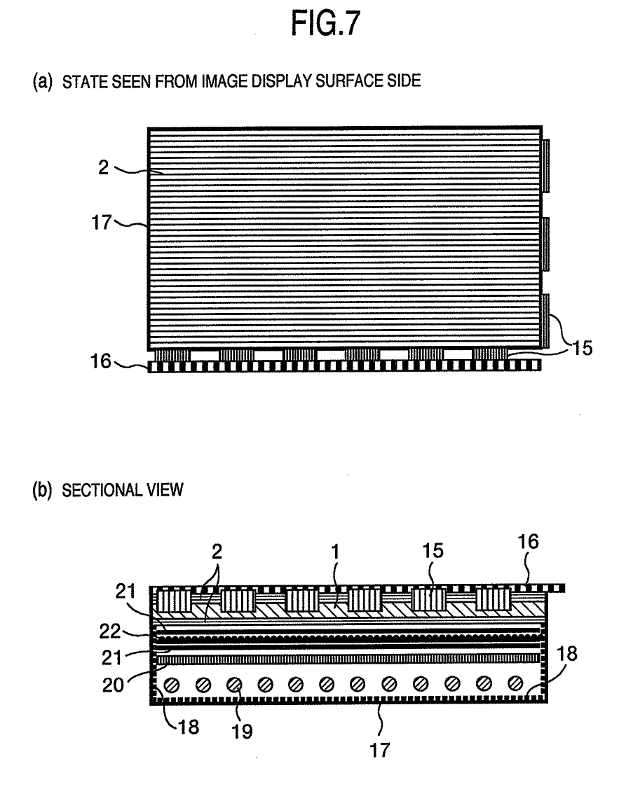

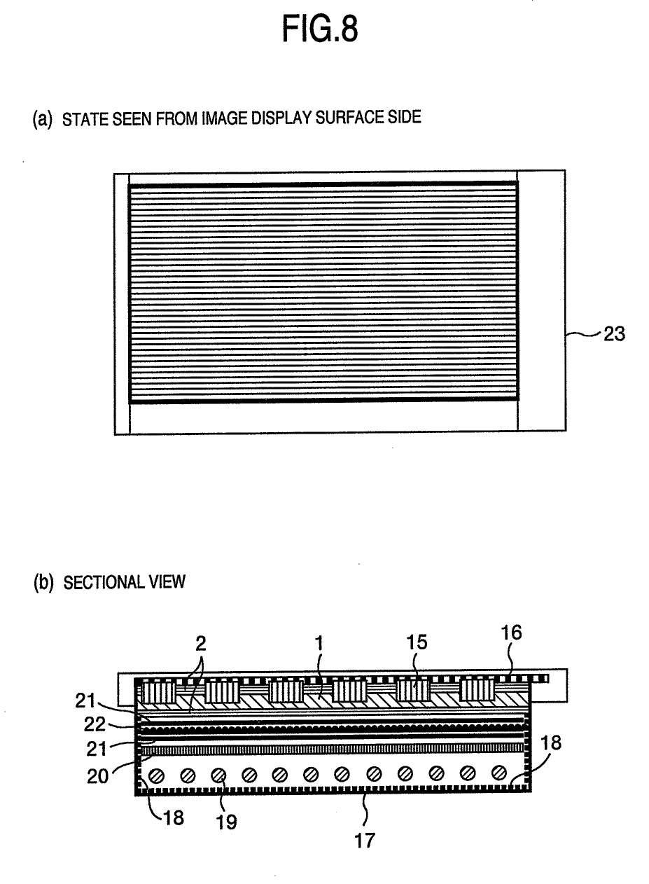

FIGS. 7 and 8 show details of the polarizing plate, the liquid crystal panel and the backlight. LCD control driver ICs 15 are disposed on a lower portion of the liquid crystal panel, and are connected by a FPC board 16. The backlight and the liquid crystal panel are housed in a casing 17 for the backlight and the liquid crystal. A reflective sheet 18 is laid on an inner surface of the casing to reflect rays of light emitted from cold cathode fluorescent lamps 19 and other rays of light so that the light is used as much as possible for image display. The light traveling from the cold cathode fluorescent lamps toward the image display surface first passes through a diffusion plate 20 to be further diffused. The light thereafter passes through optical sheets such as a diffusion sheet 21 and a prism sheet 22 and enters the liquid crystal panel. A top lid 23 is provided to prevent the liquid crystal panel from moving.

During lighting of the backlight for a long time period, the liquid crystal panel is heated by heat generated by lighting. An upper portion of the liquid crystal panel in particular is heated more strongly and the temperature of the upper portion increases corresponding. If the LCD control driver ICs are connected to the upper portion, they are heated so strongly that damage to elements by heat is considerably large, resulting in a reduction in durability of the panel. Even if there is no damage to the elements, a problem may arise that image blur occurs if heat is conducted to the liquid crystal panel to increase the temperature of the liquid crystal above the operating temperature. Therefore it is ideal to dispose the LCD control driver ICs on a lower portion of the liquid crystal panel. In a case where the LCD control driver ICs are disposed on a lower portion of the liquid crystal panel in a conventional liquid crystal display device with no front plate, however, there is a possibility of a water droplet entering some of the LCD control driver ICs via the image display portion, i.e., the polarizing plate, to cause a short circuit when the liquid crystal display device is wiped with a wet cloth or the like. Therefore, a design to dispose the LCD control driver ICs on a lower portion of the liquid crystal panel requires a certain waterproofing effect under ordinary handling by a user. The provision of the front plate produces a waterproofing effect and enables the LCD control driver ICs to be disposed on a lower portion of the liquid crystal panel, thus making it possible to lengthen the lives of the LCD control driver ICs and the liquid crystal panel.

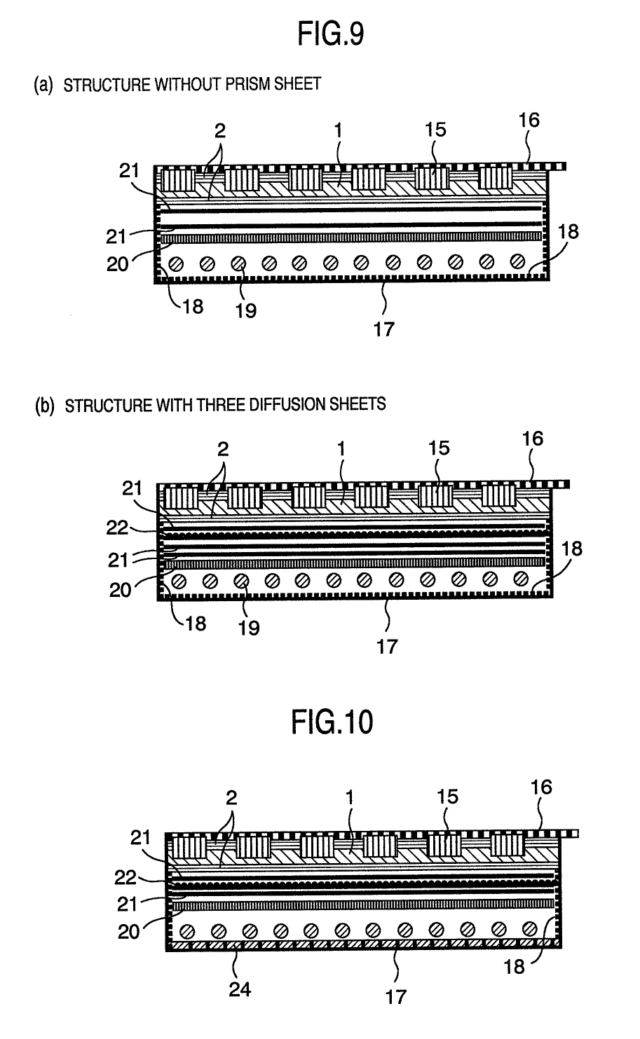

FIGS. 9(A) and 9(B) show structures differing in the number of diffusion sheets, the number of prism sheets and the construction of these sheets between the backlight and the polarizing plate and between the backlight and the liquid crystal panel from those in FIGS. 8(A) and 8(B). A selection is made from these constructions and other similar forms according to the performance of the diffusion plate, diffusion of light from the backlight, etc., at the time of designing the display device.

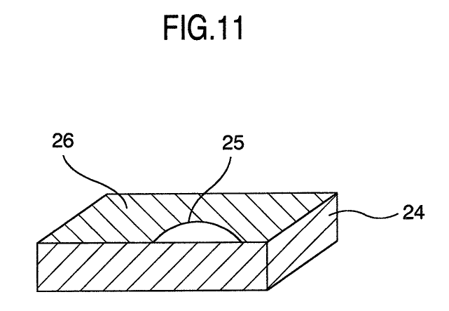

While cold cathode fluorescent lamps are used in the arrangements shown in FIGS. 7 to 9, FIG. 10 shows a construction in which light emitting diodes (LEDs) 24. FIG. 11 shows the structure of each light emitting diode. The light emitting diode has a reflective surface 26 around a light emitting portion 25. Use of cold cathode fluorescent lamps or light emitting diodes or both cold cathode fluorescent lamps and light emitting diodes is selected at the time of designing the display device.

(3) Holding Components from Backlight to Front Plate in Housing

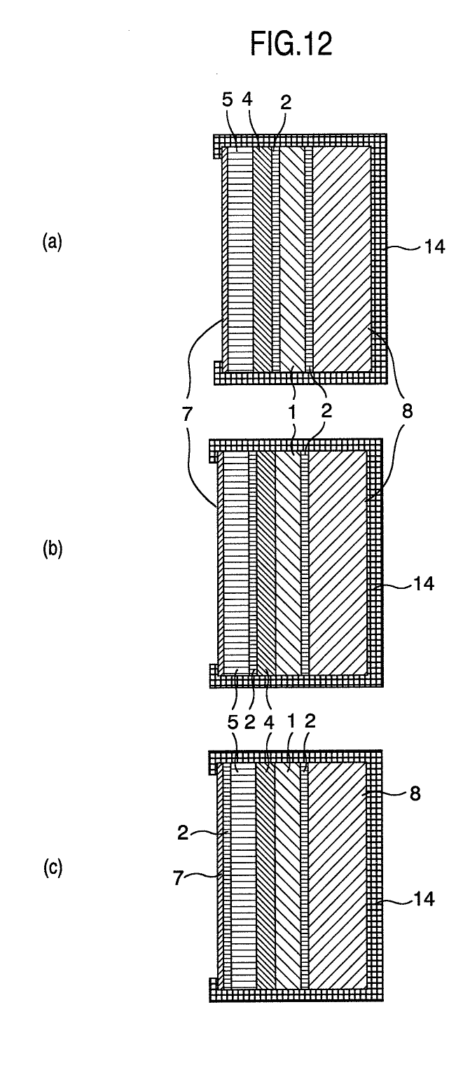

In personal computer monitors and liquid crystal television sets currently on the market, a control system, a power supply, outer frames, etc., are attached to a liquid crystal module (in which the backlight, polarizing plate, liquid crystal panel and polarizing plate shown in FIG. 6(A) are held together in a housing) to enable functioning as an image display device. As shown in FIG. 12(A), the transparent organic medium layer, the front plate and the other inner components are held in the housing. This construction has the advantage of enabling making a personal computer monitor or a liquid crystal television display without changing the conventional liquid crystal module manufacturing process.

FIGS. 12(B) and 12(C) show cases where the polarizing plate is attached on the light incidence side or the light emitting side of the front plate. The effects of these constructions are the same as those of the constructions shown in FIGS. 4(B) and 4(C) with respect to the above-described case (1).

### (4) Fixing Front Plate and Housing

In the constructions shown in FIGS. 12(A) to 12(C), the front plate and the other inner components are held in the housing. For example, in a case where a 2 mm thick glass sheet is used as a front plate in a 32 inch liquid crystal television display, the front plate itself weighs about 1.5 kg. In case where a 3 mm thick glass sheet is used, it weighs about 2.2 kg. Then it becomes necessary for the housing to use a thicker member to hold the front plate in comparison with the housing in the conventional display device. This leads to an increase in weight of the liquid crystal television, which is undesirable.

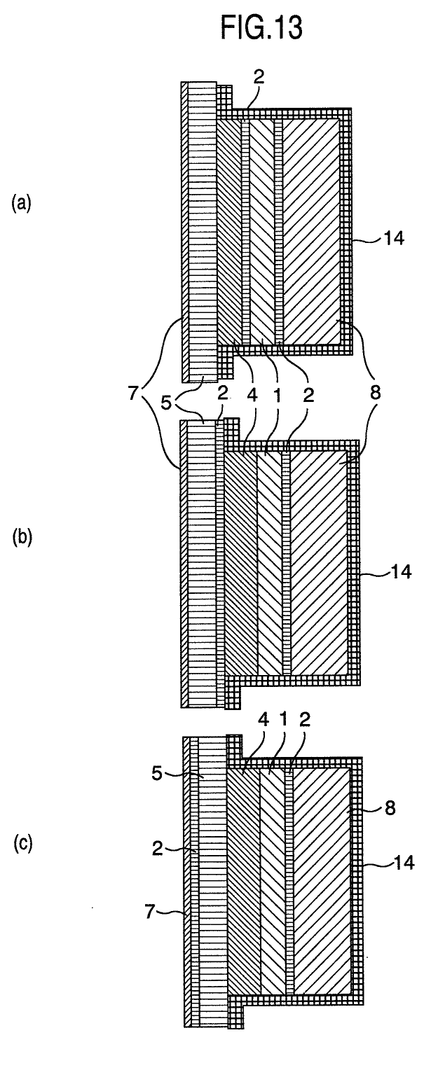

If the front plate and the housing are fixed to each other as shown in FIG. 13(A), not the housing alone but the housing and the front plate can hold the other components in cooperation with each other. In such a case, there is no need to increase the thickness of the member for the housing. That is, the amount of use of the material can be reduced, a corresponding reduction in cost can be achieved and the member can be reduced in thickness to obtain the advantage of facilitating working on the member.

FIGS. 13(B) and 13(C) show cases where the polarizing plate is attached on the light incidence side or the light emitting side of the front plate. The effects of these constructions are the same as those of the constructions shown in FIGS. 4(B) and 4(C) with respect to the above-described case (1).

### (5) Holding Polarizing Plate and Liquid Crystal Panel by Transparent Organic Medium Layer

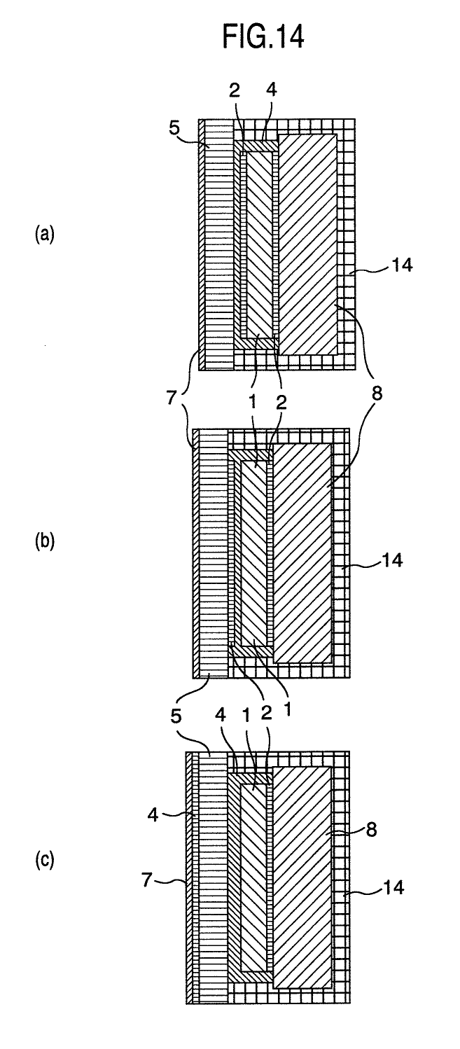

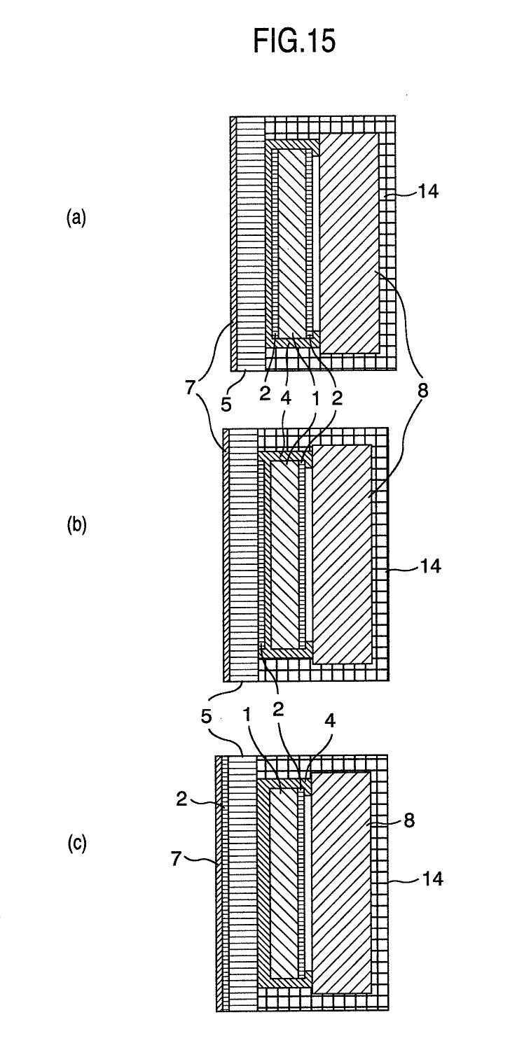

As shown in FIG. 14(A) and FIG. 15(A), the polarizing plate and the liquid crystal panel are held by the transparent organic medium layer and these members are held on the front plate. In this case, only the backlight is held by the housing. Therefore the housing can be reduced in thickness in comparison with the above-described case (4), so that the amount of use of the material can be reduced, a corresponding reduction in cost can be achieved and the member can be further reduced in thickness to obtain the advantage of facilitating working on the member.

FIGS. 14(B) and 14(C) and FIGS. 15(B) and 15(C) show cases where the polarizing plate is attached on the light incidence side or the light emitting side of the front plate. The effects of these constructions are the same as that relating to FIG. 4(B) and the above-described case (1).

### DESCRIPTION OF PREFERRED EMBODIMENT

The present invention will be described more concretely with respect to examples thereof. However, the scope of the present invention is not limited to the examples described below.

In the examples described below,

Example 1 relates to interfacial reflection depending on the existence/nonexistence of the transparent organic medium;

Example 2 relates to liquidproofness of the front plate;

Examples 3 to 6 relate to an improvement in contrast by an additive to the transparent organic medium;

Examples 7 to 11 and comparative examples 1 and 2 relate to sharpness; and

Examples 6 to 10 and comparative examples 3 to 5 relate to screen distortion.

### EXAMPLE 1

Two liquid crystal modules were made. Each liquid crystal module was of a construction such that a liquid crystal panel to which two polarizing plates were attached was provided on the light emitting side of a backlight. A 1.8 mm thick glass plate was provided as a front plate on one of these liquid crystal modules, with polyisobutylene interposed therebetween as a transparent organic medium. An antiglare-processed film of 3% haze was attached to the surface of the front plate on the light emitting side. The thickness of the polyisobutylene was about 1 mm. The same glass plate was provided on the other liquid crystal module with an air layer interposed therebetween, without filling the gap with polyisobutylene. An antiglare-processed film of 3% haze was attached to the surface of the front plate on the light emitting side.

A comparison was made between the modules with the front plates to find that stronger surface reflection appears on the module not filled with polyisobutylene. The measured reflectance on the module not filled with polyisobutylene was about 12%, while the measured reflectance on the module filled with polyisobutylene was about 4%. Since the antiglare film was provided on the surface, reflected light was scattered, external image reflection was reduced, and an image as sharp as an image obtained by a module with no front plate was obtained. Thus, it was demonstrated that even in the case where the front plate was provided the filling of the gap between the front plate and the polarizing plate with polyisobutylene and the provision of the antiglare layer on the surface made it possible to reduce interfacial reflection and external image reflection.

Other modules of the same construction were made by setting the thickness of the polyisobutylene layer to about 0.1 mm and to 10 mm. Each module had a reflectance of about 4%.

The same effect as that described above can be obtained if the refractive index of the substrate of the front plate is close to that of the glass substrate. For example, a transparent resin substrate such as an acrylic resin substrate has a refractive index of about 1.5 substantially equal to that of the glass substrate. A composite substrate formed by attaching a transparent resin substrate and a glass substrate to each other also has a refractive index of about 1.5. With each of these substrate, therefore, the same effect as that described above can also be obtained.

The transparent organic medium is not limited to polyisobutylene. Any other material may be used to obtain the same effect if it satisfies the following equation:

n₀−0.2<n<n₀+0.2

where n is the refractive index of the material used as the transparent organic medium and n₀ is the refractive index of the front plate.

The transparent organic medium has the function of bonding and fixing the panel and the front plate to each other. Therefore a material adhesive and transparent may suffice as the transparent organic medium.

### EXAMPLE 2

Two liquid crystal modules were made. Each liquid crystal module was of a construction such that a liquid crystal panel to which two polarizing plates were attached was provided on the light emitting side of a backlight are made. A control system, a power supply and other components were mounted on each of the two liquid crystal modules, thereby making image display devices. Also, LCD control driver ICs were mounted on a lower portion of each liquid crystal module. A 2 mm thick glass plate was provided as a front plate on one of these liquid crystal display devices, with polyisobutylene interposed therebetween as a transparent organic medium. The thickness of the polyisobutylene was about 1 mm.

A weak alkaline glass cleaner was sprayed to remove dust on the screen, and the screen was thereafter wiped with a cloth. Then a portion of the screen of the image display device on which no front plate was provided stopped displaying an image. No such a phenomenon occurred in the image display device on which the front. The malfunctioning device was examined to find that the sprayed glass cleaner fell along the screen, penetrated through the gap between the polarizing plate and the housing and reached the LCD control driver IC. A short circuit was thereby caused in wiring for the LCD control driver IC to make the portion of the screen inactive in displaying an image. The same phenomenon also occurred as a result of spraying water in which a detergent was mixed in place of the glass cleaner.

The above-described results show that the construction including the front plate is suitable for enabling the image display device to have such liquidproofness as to be resistant to screen cleaning using a liquid such as a glass cleaner or a detergent mixture solution.

### EXAMPLE 3

A liquid crystal module was made which was the same as the liquid crystal module using the transparent organic medium in Example 1 except that an acrylic resin containing 0.1 wt % of a pigment NK3981 (a product from Hayashibara Biochemical Labs., Inc.) in place of polyisobutylene was provided as the transparent organic medium between the polarizing plate and the front plate.

In the constitution according to this example, the transparent organic medium functions as a spectral absorption layer having an absorption peak at a wavelength of about 490 nm due to the effect of the mixed pigment. From this, it can be expected that a leakage of light with a wavelength of about 490 nm caused by scattering through the color filter is absorbed to achieve an increase in contrast ratio.

A color filter used in a liquid crystal panel has blue, green and red colored layers formed by using organic pigments. For example, PB15:6+PV23 for blue, PG36+PY150 for green and PR177+PY83 for red are known. An organic pigment exists in a state having a particle size of about 50 to 200 nm and being dispersed in a base polymer. Since such a pigment is a particle system in the Rayleigh scattering region, it scatters incident light from the light source disposed at the back of the liquid crystal panel, and the scattered light appears as a leakage of light in black display to reduce the contrast ratio. In a liquid crystal display device, not parallel light but diffused light is introduced into the liquid crystal panel for the purpose of maintaining the desired view angle characteristics. Therefore the influence of scattered light is considerable.

Since light is scattered in the color filter by Rayleigh scattering, it has a peak at a shorter wavelength in comparison with the original spectral characteristics. In the case of a green filter in particular, the peak wavelength is shifted from 530 nm to a shorter wavelength about 490 nm. Because of this shift, and because emission of light from the light source is in a certain wavelength region with a comparatively high luminosity factor, the largest influence on the contrast ratio results. For example, a light source using narrow-band-emission fluorescent materials has subemission from a green fluorescent material at about 490 nm. Light emitting diodes do not have a corresponding emission peak but the peak wavelength overlaps the emission region of a blue or green light emitting diode. That is, 490 nm light is singularly intensified in black display.

In this example, the transparent organic medium was given the function to absorb light about 490 nm and can thereby absorb unnecessary light about 490 nm singularly intensified in black display. Since the intensity of light about 490 nm is extremely low in white display, the intensity of transmitted light in white display is not largely influenced by absorption of light about 490 nm. Therefore the contrast ratio can be increased. In the constitution according to this example, 0.1 wt % of a pigment was added to reduce the transmittance in black display by 13%, whereby the contrast ratio was improved by 10%.

Needless to say, a pigment having an absorption peak at about 490 nm and capable of being dispersed in the transparent organic medium may suffice for functioning as a spectral absorption layer, and the above-described particular pigment in this example is not exclusively used. The amount of addition of the pigment used may be optimized by considering the absorbance of the pigment, the transmittance in black display and the transmittance in white display.

### EXAMPLE 4

Example 4 is the same as Example 3 except that a photocurable acrylic resin to which 0.2 wt % of metal nanoparticles were added was provided as the generally transparent organic medium. In this way, absorption of singular light about 490 nm scattered by color filter pigments in black display is enabled to obtain a contrast ratio improvement effect. Also, the surfaces of the metal nanoparticles are treated with a surfactant to prevent agglomeration of the nanoparticles and to enable the nanoparticles to be uniformly dispersed in the organic medium. In the constitution according to this example, 0.2 wt % of gold nanoparticles having a particle size of 10 nm or less and surface-treated by using, for example, a long-chain alkyl thiol having an acrylic group as a surfactant were added and mixed to reduce the black light transmittance by 10% and improve the contrast by 8%.

Needless to say, any metal nanoparticles may suffice if they have an absorption peak at about 490 nm and can be uniformly dispersed in the organic medium by having their surfaces treated, and the above-described particular nanoparticles in this example are not exclusively used. The amount of addition of the nanoparticles used may be optimized by considering the absorbance of the particles, the transmittance in black display and the transmittance in white display.

### EXAMPLE 5

Example 5 is the same as Example 4 except that a photocurable acrylic resin to which 0.1 wt % of 4-carboxymethylazobenzene was added was provided as the transparent organic medium, and that the process of irradiation with light at the time of setting was changed. Before photocuring of the acrylic resin, to develop absorption anisotropy, linear polarized light having a polarization ratio about 10:1 was applied at about 5 J/cm² to the substrate by using a high-voltage mercury lamp as a light source, extracting i-rays of 365 nm through an interference filter, and using a pile polarizer in which quartz substrates were stacked on each other. The direction of polarization of the applied polarized light was set in correspondence with the shorter-side direction of the substrate. Thereafter, ultraviolet rays in the range from 250 to 450 nm were applied to the front side to set the acrylic resin provided as the transparent organic medium. These rays of light may alternatively be applied simultaneously with each other. An absorption axis was thereby produced in the transparent organic medium in correspondence with the longer-side direction of the substrate. This process is performed for the purpose of setting the absorption axis of the transparent organic medium in correspondence with the absorption axis of the polarizing plate on the front side of the liquid crystal panel used in this example, i.e., the polarizing plate disposed on the observer side. If the absorption axis of the front-side polarizing plate of the liquid crystal panel used corresponds to the shorter-side direction, the plane of polarization of the applied polarized light may be set in correspondence with the longer-side direction of the substrate. In this example, a material in which an absorption axis is produced in a direction perpendicular to the direction of polarization of the applied polarized light was used. In a case where a material having an absorption axis corresponding to the plane of polarization of the applied polarized light, e.g., a material in which photooxidation is caused along the direction of polarization of the applied polarized light is used, the direction of polarization of the applied polarized light may be changed. Also, the same effect can be obtained if a photosensitive material in which uniaxial absorption anisotropy is developed by irradiation with polarized ultraviolet rays is used. The above-described particular compound in this example is not exclusively used. The amount of addition may be optimized according to the development of anisotropy of the photosensitive material.

The transparent organic medium in this example functions as a polarizing plate auxiliary to the polarizing plate on the observer side, so that even a weak uniaxial anisotropy is effective in reducing a leakage of light in black display to increase the contrast ratio. In this example, the luminance in black display was reduced by 5% and the contrast ratio was improved by 5%.

### EXAMPLE 6

Example 6 is the same as Example 5 except that a photocurable acrylic resin to which 0.12 wt % of DIRECT ORANGE 39 was added was provided as the transparent organic medium. The transparent organic medium in this example exhibits dichroism in the range of wavelength from 400 to 500 nm. Accordingly, a leakage of light having an increased intensity in a shorter-wavelength region in black display can be absorbed with efficiency, while there is substantially no influence of absorption on white display, thus making it possible to improve the contrast ratio and correct the color tone in black display. Any pigment may suffice if it has dichroism and can be added to the transparent organic medium.

In general, in a liquid crystal display device, the color tone in black display is more bluish than the color tone in white display. This is due to a wavelength dependence of the degree of polarization by the polarizing plate and because leakage of light is increased in the wavelength region from 400 to 450 nm in black display. Leakage of light in the region from 400 to 450 mm was absorbed by the transparent organic medium containing the dichroic pigment according to this example. The color tone in black display became changed closer to achromatism and the contrast ratio was increased by 3%.

### EXAMPLE 7

A liquid crystal module having a structure in which a polarizing plate, a liquid crystal panel and a polarizing plate were stacked on a backlight was made. The liquid crystal module used in this example was a WXGA-type 32-inch module having a pixel size of 0.511 mm. The distance from the color filter in the liquid crystal panel to the polarizing plate was 0.9 mm. To improve the shock resistance of the panel, a 1.8 mm thick front plate to which an antiglare film of 5% haze was attached was provided on the front side of the panel, with a 1.0 mm thick transparent organic medium interposed therebetween. In the module thus constructed, the distance from the color filter to the outermost surface of the image display portion was 3.7 mm. The transparent organic medium also had the effect of reducing interfacial reflection between the panel and the front plate.

The blur width was measured from an enlarged photograph of a black-and-white image. The blur width was 0.15 mm and ⅔ or less of the pixel size (0.51 mm). It was confirmed that the image was markedly sharp and no substantial blur was perceivable in the image.

### EXAMPLE 8

A 32-inch Hi-Vision-type panel (pixel size: 0.363 mm) was used in place of the 32-inch WXGA-type panel and evaluation was made in the same manner as in Example 7. The blur width was the same, 0.15 mm, and a sharp image in which no substantial blur is perceivable was displayed.

### EXAMPLE 9

A liquid crystal module having the same construction as that in Example 7 except that the thickness of the transparent resin was changed from 1.0 mm to 0.3 mm and the film of 5% haze was replaced with an 8% antiglare-processed film was made.

The blur width was measured and found to be 0.20 mm. A comparatively sharp image was observed even by using the 32-inch WXGA-type panel. Since the haze value is high, external image reflection was not noticeable even when a dim image was viewed in a light room.

### EXAMPLE 10

A liquid crystal module having the same construction as that in Example 7 except that the thickness of the front plate was changed from 1.8 mm to 1.1 mm and the film of 5% haze was replaced with a 52% antiglare-processed film was made.

The blur width was measured and found to be 0.30 mm. A comparatively sharp image was observed even by using the 32-inch WXGA-type panel. Since the glass thickness was 1.1 mm, a reduction in thickness and a reduction in weight were achieved in comparison with Examples 7 to 9.

### EXAMPLE 11

A liquid crystal module was made which was the same as Example 10 except that the thickness of transparent resin was changed from 1.0 mm to 0.3 mm.

The blur width was measured and found to be 0.25 mm. A comparatively sharp image was observed even by using the 32-inch WXGA-type panel. Since the thickness of the transparent resin layer was reduced, a reduction in thickness of the liquid crystal module and the liquid crystal display device was achieved in comparison with Examples 7 to 10.

### COMPARATIVE EXAMPLE 1

A liquid crystal module having the same construction as that in Example 7 except that the thickness of the front plate was changed from 1.8 to 2.8 mm; the thickness of the transparent resin was changed from 1.0 mm to 2.8 mm; and the haze of the antiglare-processed film was changed from 5% to 52% was made.

The blur width was measured and found to be 0.44 mm, larger than ⅔ of the pixel size, and an unsharp image was observed.

### COMPARATIVE EXAMPLE 2

A liquid crystal module having the same construction as that in Example 7 except that the haze of the antiglare-processed film was changed from 5% to 25% was made.

The blur width was measured and found to be 0.39 mm, larger than ⅔ of the pixel size, and an unsharp image was observed.

TABLE 2
Examples of the present invention and comparative examples relating to sharpness

| | | Distance from image formation surface to | | | | | | |
|---|---|---|---|---|---|---|---|---|
| | | outermost surface | | | | | | |
| | | (mm) | | | | Pixel | Blur | |
| | Haze | Panel glass + polarizing | Transparent | Front | | size | width | |
| | (%) | plate | resin | plate | Sum | (mm) | (mm) | Evaluation |
| Example 7 | 5 | 0.9 | 1.0 | 1.8 | 3.7 | 0.511 | 0.15 | Sharp |
| Example 8 | ↑ | ↑ | ↑ | ↑ | ↑ | 0.363 | 0.15 | ↑ |
| Example 9 | 8 | ↑ | 0.3 | ↑ | 3.0 | 0.511 | 0.20 | ↑ |
| Example 10 | 52 | ↑ | 1.0 | 1.1 | ↑ | ↑ | 0.30 | ↑ |
| Example 11 | ↑ | ↑ | 0.3 | ↑ | 2.3 | ↑ | 0.25 | ↑ |
| Comparative | 52 | ↑ | 2.8 | 2.8 | 6.5 | ↑ | 0.44 | Unsharp |
| Example 1 | | | | | | | | |
| Comparative | 25 | ↑ | 1.0 | 1.8 | 3.7 | ↑ | 0.39 | ↑ |
| Example 2 | | | | | | | | |

From Examples 7 to 11 and Comparative Examples 1 and 2, it was shown that securing the desired sharpness of an image was enabled when the blur width was limited to ⅔ or less of the pixel size.

### EXAMPLE 12

A liquid crystal module having the same construction as that in Example 7 was made.

The surface of the front plate was pressed by applying a load of about 2 kg/cm² thereto and the load application point was moved from left to light through a distance of 100 mm at a speed of about 100 mm/sec while continuing pressing. No mark was left by pressing and the displayed image was not changed.

### EXAMPLE 13

A liquid crystal module having the same construction as that in Example 9 was made.

The surface of the front plate was pressed by applying a load of about 2 kg/cm² thereto and the load application point was moved from left to light through a distance of 100 mm at a speed of about 100 mm/sec while continuing pressing. No mark was left by pressing and the displayed image was not changed.

### EXAMPLE 14

A liquid crystal module having the same construction as that in Example 10 was made.

The surface of the front plate was pressed by applying a load of about 2 kg/cm² thereto and the load application point was moved from left to light through a distance of 100 mm at a speed of about 100 mm/sec while continuing pressing. No mark was left by pressing and the displayed image was not changed.

### EXAMPLE 15

A liquid crystal module having the same construction as that in Example 11 was made.

The surface of the front plate was pressed by applying a load of about 2 kg/cm² thereto and the load application point was moved from left to light through a distance of 100 mm at a speed of about 100 mm/sec while continuing pressing. No mark was left by pressing and the displayed image was not changed.

### EXAMPLE 16

A liquid crystal module having the same construction as that in Example 11 except that the thickness of the transparent resin was changed from 0.3 mm to 0.1 mm was made.

The surface of the front plate was pressed by applying a load of about 2 kg/cm thereto and the load application point was moved from left to light through a distance of 100 mm at a speed of about 100 mm/sec while continuing pressing. No mark was left by pressing and the displayed image was not changed.

### COMPARATIVE EXAMPLE 3

A liquid crystal module having the same construction as that in Example 11 except that the thickness of the transparent resin was changed from 0.3 mm to 0.05 mm was made.

The surface of the front plate was pressed by applying a load of about 2 kg/cm thereto and the load application point was moved from left to light through a distance of 100 mm at a speed of about 100 mm/sec while continuing pressing. A mark caused by pressing remained for several seconds, and the image was unrecognizable during this time period. This phenomenon was due to disturbance in the gap spacing of the liquid crystal layer in the liquid crystal panel caused by pressing. This disturbance affected the image.

### COMPARATIVE EXAMPLE 4

A liquid crystal module having the same construction as that in Example 11 except that the thickness of the transparent resin was changed from 0.3 mm to 0.025 mm was made.

The surface of the front plate was pressed by applying a load of about 2 kg/cm² thereto and the load application point was moved from left to light through a distance of 100 mm at a speed of about 100 mm/sec while continuing pressing. A mark caused by pressing remained for several seconds, and the image was unrecognizable during this time period.

### COMPARATIVE EXAMPLE 5

A liquid crystal module having the same construction as that in Example 11 except that the thickness of the front plate was changed from 1.1 mm to 0.8 mm was made.

The surface of the front plate was pressed by applying a load of about 2 kg/cm² thereto and the load application point was moved from left to light through a distance of 100 mm at a speed of about 100 mm/sec while continuing pressing. A mark caused by pressing remained for several seconds, and the image was unrecognizable during this time period.

From Examples 12 to 16 and Comparative Examples 1 and 3 to 5, it was shown that suppression of disturbance in the gap spacing of the liquid crystal layer caused by pressing was enabled when the distance from the color filter, i.e., the image formation surface, to the antiglare layer surface of the front plate was 2.1 mm or more.

TABLE 3
Examples of the present invention and comparative examples relating to
remaining of mark after pressing with finger

| | Distance (mm) | | | | |
|---|---|---|---|---|---|
| | Panel glass + polarizing | Transparent | | | |
| | plate | resin | Front plate | Sum | Evaluation |
| Example 12 | 0.9 | 1.0 | 1.8 | 3.7 | No mark left |
| Example 13 | ↑ | 0.3 | ↑ | 3.0 | ↑ |
| Example 14 | ↑ | 1.0 | 1.1 | 3.0 | ↑ |
| Example 15 | ↑ | 0.3 | ↑ | 2.3 | ↑ |
| Example 16 | ↑ | 0.1 | ↑ | 2.1 | ↑ |
| Comparative | ↑ | 0.05 | ↑ | 2.05 | Mark left |
| Example 3 | | | | | |
| Comparative | ↑ | 0.025 | ↑ | 2.025 | ↑ |
| Example 4 | | | | | |
| Comparative | ↑ | 0.3 | 0.8 | 2.0 | ↑ |
| Example 5 | | | | | |

### EXAMPLE 17

Liquid crystal modules to which a front plate and a transparent organic medium were attached were made. Antiglare film having a haze of 10, 12, 15, 18, 22 or 25% was attached to the front side of the panel, with a 0.5 mm thick transparent organic medium interposed therebetween. The thickness of the front plate was set to 0.7, 1.4, 1.8, 2.8, 3.8 or 4.8 mm. The liquid crystal module used in this example was of a 32-inch WXGA type and had a pixel size of 0.511 mm. The distance from the color filter in the liquid crystal panel to the polarizing plate in each module was 0.9 mm. According to the above-described construction, the distance from the color filter to the outermost layer of the image display portion was 2.1, 2.8, 3.2, 4.2, 5.2 or 6.2 mm. The degree of blur was checked with the eyes to obtain results shown below. Ten subjects participated in the test.

The numeric values in the following table are the values of L×H/D where L is the distance from the color filter surface, i.e. the image formation surface, to the front plate surface, H is the haze of the antiglare layer, and D is the pixel size of the liquid crystal module.

TABLE 4
Permissible heze × distance when pixel size is 0.51 mm

| | Haze (%) | | | | | |
|---|---|---|---|---|---|---|
| Distance (mm) | 10 | 12 | 15 | 18 | 22 | 25 |
| 2.1 | 41 (◯) | 49 (◯) | 62 (◯) | 74 (◯) | 91 (◯) | 103 (◯) |
| 2.8 | 55 (◯) | 66 (◯) | 82 (◯) | 99 (◯) | 121 (◯) | 137 (◯) |
| 3.2 | 63 (◯) | 75 (◯) | 94 (◯) | 113 (◯) | 138 (◯) | 157 (Δ) |
| 4.2 | 82 (◯) | 99 (◯) | 124 (◯) | 148 (◯) | 181 (Δ) | 206 (X) |
| 5.2 | 102 (◯) | 122 (◯) | 153 (Δ) | 184 (Δ) | 224 (X) | 255 (X) |
| 6.2 | 122 (◯) | 146 (◯) | 182 (Δ) | 219 (X) | 267 (X) | 304 (X) |

Numeric values in the table were obtained by L · H/D.
◯ in parentheses indicates a case permitted by all ten persons,
Δ indicates a case permitted by 5 to 9 persons, and
X indicates a case permitted by 4 or fewer persons.

### EXAMPLE 18

Liquid crystal modules to which a front plate and a transparent organic medium were attached were made in the same manner as in Example 17 except that the 32-inch WXGA-type liquid crystal module was replaced with a 37-inch Hi-Vision-type liquid crystal module (pixel size: 0.42 mm). The degree of blur was checked with the eyes to obtain results shown below.

TABLE 5
Permissible haze × distance when pixel size is 0.42 mm

| | Haze (%) | | | | | |
|---|---|---|---|---|---|---|
| Distance (mm) | 10 | 12 | 15 | 18 | 22 | 25 |
| 2.1 | 50 (◯) | 60 (◯) | 75 (◯) | 90 (◯) | 110 (◯) | 125 (◯) |
| 2.8 | 67 (◯) | 80 (◯) | 100 (◯) | 120 (◯) | 147 (◯) | 167 (Δ) |
| 3.2 | 76 (◯) | 91 (◯) | 114 (◯) | 137 (◯) | 168 (Δ) | 190 (Δ) |
| 4.2 | 100 (◯) | 120 (◯) | 150 (Δ) | 180 (Δ) | 220 (X) | 250 (X) |
| 5.2 | 124 (◯) | 149 (◯) | 186 (Δ) | 223 (X) | 272 (X) | 310 (X) |
| 6.2 | 148 (◯) | 177 (Δ) | 221 (X) | 266 (X) | 325 (X) | 369 (X) |

Numeric values in the table were obtained by L · H/D.
◯ in parentheses indicates a case permitted by all ten persons,
Δ indicates a case permitted by 5 to 9 persons, and
X indicates a case permitted by 4 or fewer persons.

From the results shown above, it was shown that blur can be permitted by all the persons when L×H/D<150 where L is the distance from the color filter surface, i.e., the image formation surface, to the front plate surface, H is the haze of the antiglare layer, and D is the pixel size of the liquid crystal module was satisfied, and that blur was permitted by half of the persons when L×H/D<200.

According to the present invention, as described above, a front plate is provided in an image display panel with a transparent organic medium is interposed therebetween, thereby improving breakage resistance. Also, it has been shown that the reflectance on the air interface is reduced in comparison with a case where no organic medium is provided.

Further, it has been shown that external image reflection can be reduced by providing an antiglare layer. In addition, it has been shown that deterioration in sharpness can be reduced by specifying the distance from the image formation surface to the antiglare layer and the haze of the antiglare layer with respect to the pixel size.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a polarizing plate attached to the liquid crystal panel on the light emitting side of the same;
a transparent organic medium layer provided between the front plate and the liquid crystal panel; and
an antiglare layer provided on the front plate on the side of the same not facing the transparent organic medium layer.

2. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel;
a polarizing plate attached to the front plate on the transparent organic medium layer side of the same; and
an antiglare layer provided on the front plate on the side of the same not facing the transparent organic medium layer.

3. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a polarizing plate attached to the liquid crystal panel on the light emitting side of the same;
a transparent organic medium layer provided between the front plate and the liquid crystal panel; and
an antiglare layer provided on the front plate on the side of the same not facing the transparent organic medium layer,
wherein the backlight, the liquid crystal panel and the two polarizing plates are housed in a housing, and the front plate is attached to the polarizing plate with the transparent organic medium layer interposed therebetween.

4. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a polarizing plate attached to the liquid crystal panel on the light emitting side of the same;
a transparent organic medium layer provided between the front plate and the liquid crystal panel; and
an antiglare layer provided on the front plate on the side of the same not facing the transparent organic medium layer,
wherein the backlight, the liquid crystal panel, the two polarizing plates, the transparent organic medium layer and the front plate are housed in a housing.

5. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a polarizing plate attached to the liquid crystal panel on the light emitting side of the same;
a transparent organic medium layer provided between the front plate and the liquid crystal panel; and
an antiglare layer provided on the front plate on the side of the same not facing the transparent organic medium layer,
wherein the area of the front plate is larger than the liquid crystal panel, and the front plate and a housing are joined to each other.

6. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel;
a polarizing plate attached to the front plate on the transparent organic medium layer side of the same; and
an antiglare layer provided on the front plate on the side of the same not facing the transparent organic medium layer,
wherein the backlight, the liquid crystal panel and the polarizing plate are housed in a housing, and the front plate is attached to the polarizing plate with the transparent organic medium layer interposed therebetween.

7. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel;
a polarizing plate attached to the front plate on the transparent organic medium layer side of the same; and
an antiglare layer provided on the front plate on the side of the same not facing the transparent organic medium layer,
wherein the backlight, the liquid crystal panel, the polarizing plate, the transparent organic medium layer and the front plate are housed in a housing.

8. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel;
a polarizing plate attached to the front plate on the transparent organic medium layer side of the same; and
an antiglare layer provided on the front plate on the side of the same not facing the transparent organic medium layer,
wherein the area of the front plate is larger than the liquid crystal panel, and the front plate and a housing are joined to each other.

9. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel; and
a polarizing plate attached to the front plate on the light emitting side of the same, with an antiglare layer provided thereon,
wherein the backlight, the liquid crystal panel and the polarizing plate are housed in a housing, and the front plate is attached to the polarizing plate with the transparent organic medium layer interposed therebetween.

10. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel; and
a polarizing plate attached to the front plate on the light emitting side of the same, with an antiglare layer provided thereon,
wherein the backlight, the liquid crystal panel, the polarizing plate, the transparent organic medium layer and the front plate are housed in a housing.

11. A liquid crystal display device in which are disposed a backlight, a polarizing plate on the backlight side and a liquid crystal panel held by two glass substrates and having electrodes, a liquid crystal layer, an alignment layer and a color filter therein, the liquid crystal display device comprising:
a transparent front plate provided on the liquid crystal panel on the side of the same not facing the backlight;
a transparent organic medium layer provided between the front plate and the liquid crystal panel; and
a polarizing plate attached to the front plate on the light emitting side of the same, with an antiglare layer provided thereon,
wherein the area of the front plate is larger than the liquid crystal panel, and the front plate and a housing are joined to each other.

12. The liquid crystal display device according to claim 1, wherein a driver IC for controlling LCD is disposed in a lower portion of the liquid crystal display device.

13. The liquid crystal display device according to claim 1, wherein the thickness of the transparent organic medium layer is 0.1 to 10 mm.

14. The liquid crystal display device according to claim 1, wherein if the refractive index of a constituent member of the transparent organic medium layer is n and the refractive index of the front plate is n₀, these refractive indices satisfy the following expression:
n₀−0.2<n<n₀+0.2.

15. The liquid crystal display device according to claim 1, wherein the transparent organic medium layer contains a compound capable of absorbing light in a visible range.

16. The liquid crystal display device according to claim 1, wherein the compound capable of absorbing light in a visible range is a compound having a uniaxial anisotropy.

17. The liquid crystal display device according to claim 1, wherein if the distance from an image formation surface to an antiglare layer surface is L (mm), the distance L satisfies the following expression:
2.1≦L.

18. A plasma display device having a plasma display panel in which a plurality of discharge cells of one or a plurality of colors are arrayed between a pair of glass substrates, and fluorescent luminous layers of colors corresponding to the discharge cells are disposed between the glass substrates and are excited with ultraviolet rays to emit light, the plasma display device comprising:
a transparent front plate provided on the plasma display panel on the light emitting side of the same;
a transparent organic medium layer provided between the front plate and the plasma display panel; and
an antiglare layer provided on the front plate on the side of the same not facing the transparent organic medium layer.

19. The plasma display device according to claim 18, wherein the thickness of the transparent organic medium layer is 0.1 to 10 mm.

20. The plasma display device according to claim 18, wherein if the refractive index of a constituent member of the transparent organic medium layer is n and the refractive index of the front plate is n₀, these refractive indices satisfy the following expression:
n₀−0.2<n<n₀+0.2.

21. The liquid crystal display device or the plasma display device according to claim 1, wherein if the blur width of the liquid crystal display device or the plasma display device is d (mm) and the pixel size of the liquid crystal display device or the plasma display device is D (mm), the blur width satisfies the following expression:
d<2·D.

22. The liquid crystal display device or the plasma display device according to claim 1, wherein if the blur width of the liquid crystal display device or the plasma display device is d (mm) and the pixel size of the liquid crystal display device or the plasma display device is D (mm), the blur width satisfies the following expression:
d<(⅔)·D.

23. The liquid crystal display device or the plasma display device according to claim 1, wherein if the distance from an image formation surface to an antiglare surface in the liquid crystal display device or the plasma display device is L (mm); a haze of the antiglare is H; and the pixel size of the liquid crystal display device or the plasma display device is D (mm), the distance, the haze and the pixel size satisfy the following expression:
L·H/D<200.

24. The liquid crystal display device or the plasma display device according to claim 1, wherein if the distance from an image formation surface to an antiglare surface in the liquid crystal display device or the plasma display device is L (mm); a haze of the antiglare is H; and the pixel size of the liquid crystal display device or the plasma display device is D (mm), the distance, the haze and the pixel size satisfy the following expression:
L·H/D<150.
